(19) United States
(12) Patent Application Publication
(10) Pub. No.: US 2014/0137017 A1
(43) Pub. Date: May 15, 2014

(54) REGION MARKING FOR AN INDOOR MAP

(71) Applicant: QUALCOMM INCORPORATED, San Diego, CA (US)

(72) Inventors: Abhinav Sharma, Santa Clara, CA (US); Chandrakant Mehta, Santa Clara, CA (US); Saumitra Mohan Das, Santa Clara, CA (US)

(73) Assignee: QUALCOMM INCORPORATED, San Diego, CA (US)

(21) Appl. No.: 13/826,467

(22) Filed: Mar. 14, 2013

Related U.S. Application Data
(60) Provisional application No. 61/726,457, filed on Nov. 14, 2012.

(51) Int. Cl. G06F 3/0484

(52) U.S. Cl. CPC G06F 3/04842
USPC 715/767

(57) ABSTRACT

A computer-implemented method of marking regions of an electronic map that shows a floor plan of a building includes receiving the electronic map and displaying a user interface on a display device. The user interface includes displaying the electronic map. The method also includes receiving user input demarcating a closed region of the electronic map and receiving user input indicating an element type of the closed region. A tag is then added to the electronic map to indicate the element type of the closed region.

### CROSS-REFERENCE TO RELATED APPLICATION

This application claims the benefit of U.S. Provisional Application No. 61/726,457, filed Nov. 14, 2012. U.S. Provisional Application No. 61/726,457 is hereby incorporated by reference.

### BACKGROUND

This disclosure relates generally to electronic maps, and in particular but not exclusively, relates to electronic maps for use in indoor navigation.

Navigation systems are becoming more and more pervasive in today's market. A navigation system may be utilized to determine a route from a first location to a destination. In some navigation systems, a user may enter a start location and a destination into a mapping application, such as one of the different mapping applications commonly used on a variety of websites.

The Global Positioning System (GPS) represents one type of navigation system, which along with other types of satellite positioning systems (SPS) provide or otherwise support signal-based position location capabilities (e.g., navigation functions) in mobile stations, and particularly in outdoor environments. However, since some satellite signals may not be reliably received and/or acquired by a mobile station within an indoor environment, different techniques may be employed to enable position location services.

For example, mobile stations may attempt to obtain a position fix by measuring ranges to three or more terrestrial transmitters (e.g., wireless access points, beacons, cell towers, etc.) which are positioned at known locations. Such ranges may be measured, for example, by obtaining range measurements to the transmitters by measuring one or more characteristics of signals received from such transmitters such as, for example, signal strength, a round trip delay time, etc.

These and other position location and navigation techniques tend to be of further benefit to a user if presented with certain mapped features. For example, mapped features may relate to or otherwise identify certain physical objects, characteristics, or points of interest within a building or complex, etc. Thus, in certain instances, an indoor navigation system may provide a digital electronic map to a mobile station upon entering a particular indoor area, e.g., in response to a request for position assistance data. Such a map may show indoor features such as doors, hallways, entry ways, walls, etc., or points of interest such as bathrooms, pay phones, room names, stores, etc. Such a digital electronic map may be stored at a server to be accessible by a mobile station through selection of a URL, for example. However, some maps received by the server do not have all or any of the indoor features identified.

### SUMMARY

These problems and others may be solved according to various embodiments, described herein.

According to some aspects of the present disclosure, a computer-implemented method of marking regions of an electronic map that shows a floor plan of a building structure includes displaying a user interface on a display device. The user interface includes displaying the electronic map. The method also includes receiving user input demarcating a closed region of the electronic map and receiving user input indicating an element type of the closed region. The method further includes adding a tag to the electronic map to indicate the element type of the closed region.

According to another aspect of the present disclosure, a computer-readable medium including program code stored thereon for marking regions of an electronic map that shows a floor plan of a building structure. The program code includes instructions to display a user interface on a display device. The user interface includes displaying the electronic map. The program code further includes instructions to receive user input demarcating a closed region of the electronic map and to receive user input indicating an element type of the closed region. The program code also includes instructions to add a tag to the electronic map to indicate the element type of the closed region.

In a further aspect of the present disclosure, a map server includes memory and a processing unit. The memory is adapted to store program code for marking regions of an electronic map that shows a floor plan of a building structure. The processing unit is adapted to access and execute instructions included in the program code. When the instructions are executed by the processing unit, the processing unit directs the map server to display a user interface on a display device, the user interface having the electronic map. The processing unit also directs the map server to receive user input demarcating a closed region of the electronic map and user input indicating an element type of the closed region. The processing unit then adds a tag to the electronic map to indicate the element type of the closed region.

In yet another aspect of the present disclosure, a system for marking regions of an electronic map that shows a floor plan of a building structure includes means for displaying a user interface on a display device, the user interface having the electronic map. The system also includes means for receiving user input demarcating a closed region of the electronic map and means for receiving user input indicating an element type of the closed region. Further included in the system are means for adding a tag to the electronic map to indicate the element type of the closed region.

The above and other aspects, objects, and features of the present disclosure will become apparent from the following description of various embodiments, given in conjunction with the accompanying drawings.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a functional block diagram of a navigation system.

FIG. 2 is a functional block diagram of a map server.

FIG. 3 illustrates a process of marking regions of an indoor map.

FIG. 4 illustrates a user interface displaying an indoor map having unmarked regions.

FIG. 5 illustrates a user interface displaying an indoor map having several marked regions.

### DETAILED DESCRIPTION

Reference throughout this specification to “one embodiment”, “an embodiment”, “one example”, or “an example” means that a particular feature, structure, or characteristic described in connection with the embodiment or example is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. Any example or embodiment described herein is not to be construed as preferred or advantageous over other examples or embodiments.

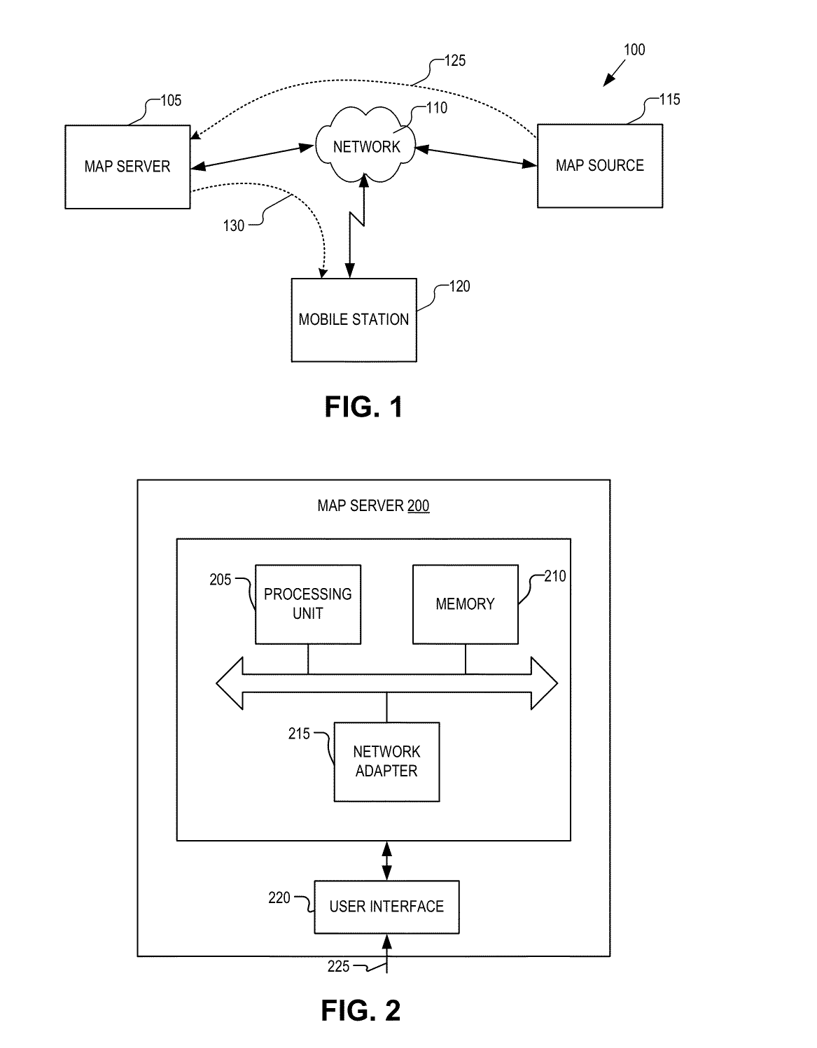

FIG. 1 is a functional block diagram of a navigation system 100. As shown, navigation system 100 may include a map server 105, a network 110, a map source 115, and a mobile device 120. Map source 115 may comprise a memory and may store electronic maps that may or may not contain any annotations or other information indicating locations of entryways or hallways/corridors, for example. Electronic maps may include drawings of line segments which may be indicate various interior features of a building structure.

In one implementation, map source 115 may create electronic maps by scanning paper blueprints for a building into an electronic format that does not include any annotations. Alternatively, map source 115 may acquire electronic maps from an architectural firm that designed a building or from public records, for example.

Electronic maps 125 may be transmitted by map source 115 to map server 105 via network 110. Map source 115 may comprise a database or server, for example. In one implementation, map server 105 may transmit a request for a particular basic electronic map to map source 115 and in response the particular electronic map may be transmitted to map server 105. One or more maps in map source 115 may be scanned from blueprint or other documents.

Map server 105 may provide a user interface on a display device for a user to identify one or more features of the electronic map, such as entryways, hallways, or other items on the electronic map. In response to user input, the map is tagged to identify various regions of the electronic map as corresponding with a known feature (e.g., wall, building boundary, entryway, etc.).

The tagged electronic map may subsequently be utilized by a navigation system to generate various position assistance data that may be used to provide routing directions or instructions to guide a person from a starting location depicted on a map to a destination location in an office, shopping mall, stadium, or other indoor environment. As discussed above, a person may be guided through one or more hallways to reach a destination location. Electronic maps and/or routing directions 130 may be transmitted to a user's mobile station 120. For example, such electronic maps and/or routing directions may be presented on a display screen of mobile station 120. Routing directions may also be audibly presented to a user via a speaker of mobile station 120 or in communication with mobile device 120. Map server 105, map source 115 and mobile device 120 may be separate devices or combined in various combinations (e.g., all combined into mobile device 120; map source 115 combined into map server 105, etc.).

FIG. 2 is a functional block diagram of a map server 200. Map server 200 may include a processing unit 205, memory 210, and a network adapter 215. Memory 210 may be adapted to store computer-readable instructions, which are executable to perform one or more of processes, implementations, or examples thereof which are described herein. Processing unit 205 may be adapted to access and execute such machine-readable instructions. Through execution of these computer-readable instructions, processing unit 205 may direct various elements of map server 200 to perform one or more functions described herein.

Memory 210 may also store electronic maps to be analyzed and tagged by a user to determine locations of various features of a building structure included in the electronic map. For example, map server 200 may provide a user interface 220 on a display device (e.g., a monitor) for a user to identify one or more features of the electronic map, such as entryways, hallways, or other items on the electronic map. In response to user input 225, the map is tagged to identify various regions of the electronic map as corresponding with a known feature (e.g., wall, building boundary, entryway, etc.).

Network adapter 215 may then transmit one or more electronic maps to another device, such as a user's mobile device. Upon receipt of such electronic maps, a user's mobile device may present updated electronic maps via the mobile station's display device. Network adapter 215 may also receive one or more electronic maps for analysis from an electronic map source.

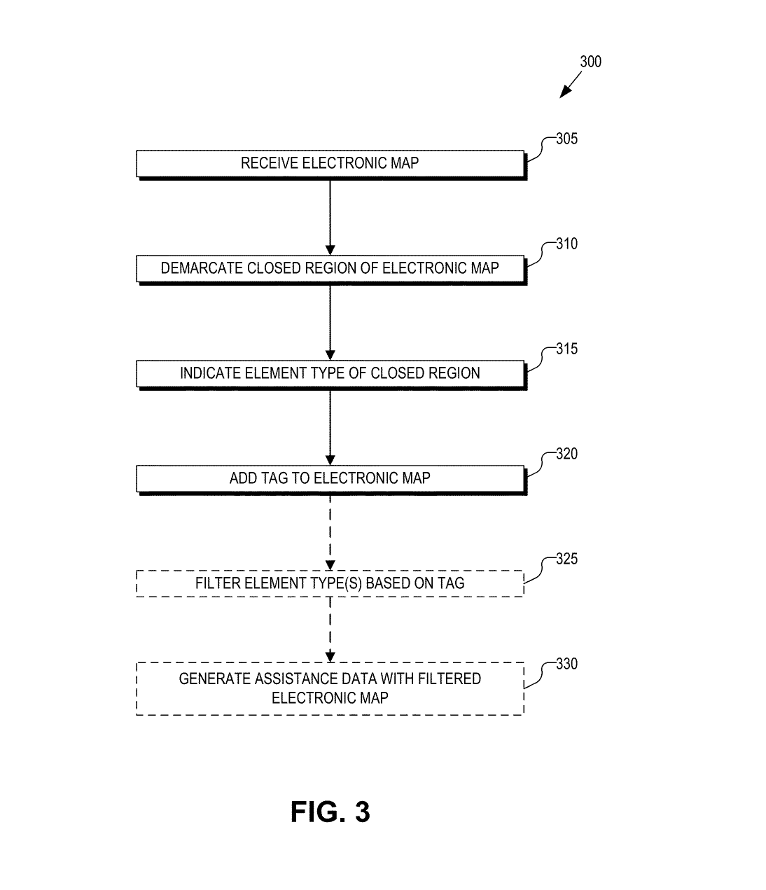

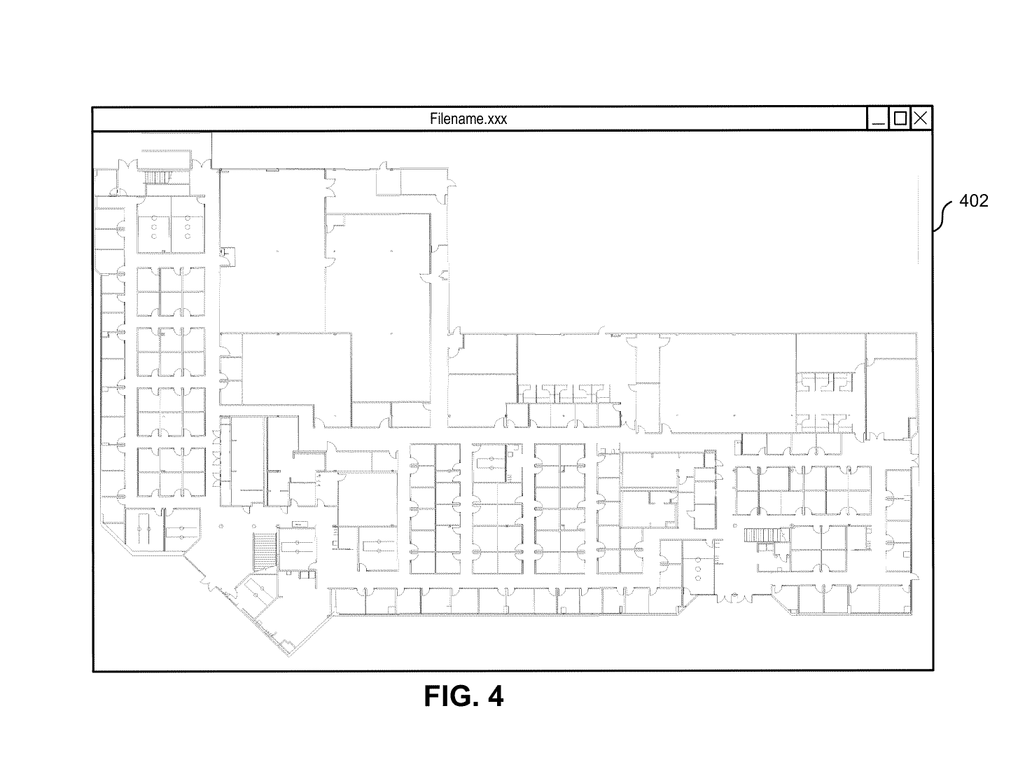

FIG. 3 illustrates a process 300 of marking regions of an indoor map. Process 300 may begin at process block 305 with the receipt of an electronic map. As discussed above an electronic map 125 may be received at map server 105 from map source 115 via network 110. The electronic map may then be displayed on a user interface of the map server. By way of example, FIG. 4 illustrates a user interface 402 displaying an indoor map. User interface 402 is one possible implementation of user interface 220 of FIG. 1. The indoor map displayed in the user interface 402 of FIG. 4 includes several unmarked regions. For example, the indoor map includes line segments that represent a building boundary, stairs, entryways, hallways, etc., all of which are not marked in the electronic map.

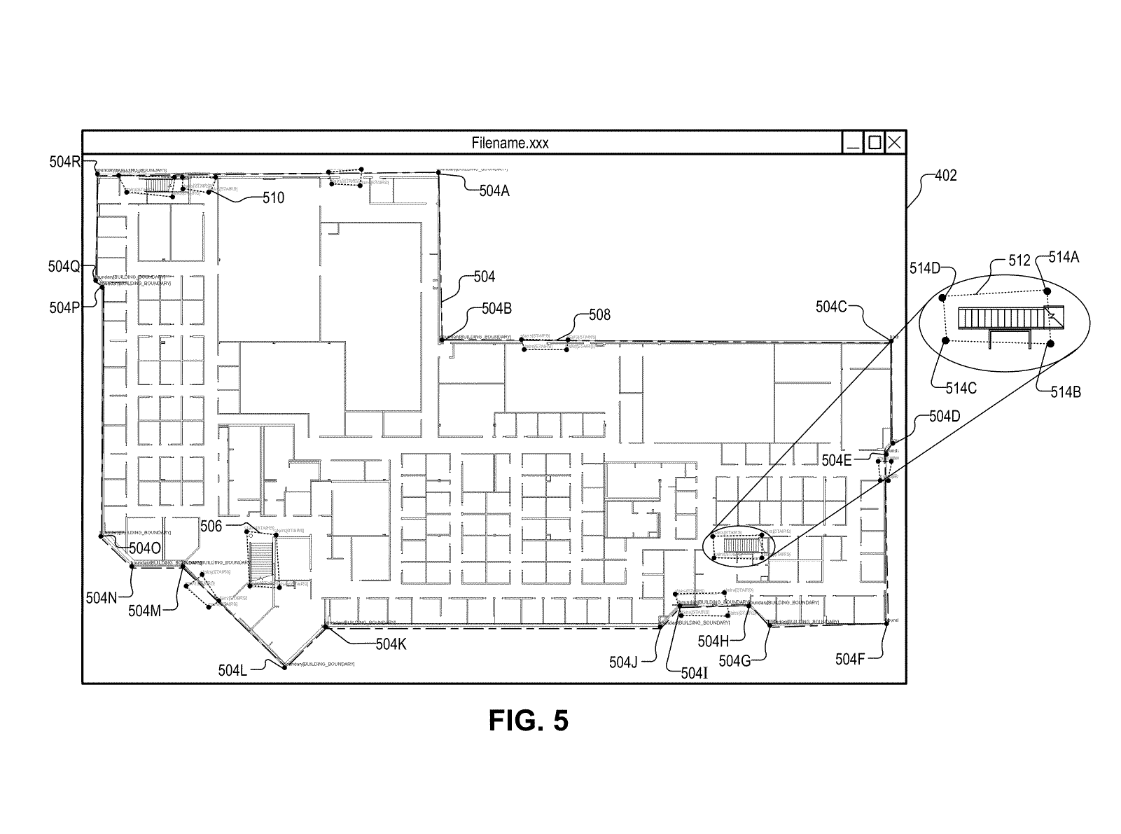

Next, in process block 310, user input 225 is received that demarcates a closed region of the electronic map. In one embodiment, the user demarcates a region by drawing a polygon, or other closed shape around the region that is to be marked. By way of example, FIG. 5 illustrates user interface 402 displaying the indoor map having several marked regions 504-512. Region 504 is a closed region representing a building boundary of the building structure, while regions 506-512, are each, a closed region demarcating stairs. Although FIG. 5 only shows the demarcation of the building boundary and stairs, other features of the building structure could be demarcated in accordance with the present disclosure, including: cubicles, elevators, entrances, exclusion areas, open areas, and hallways.

As mentioned above the user may demarcate a region by drawing a polygon to demarcate a closed region. In one embodiment, the polygon is an irregular simple polygon. That is, the polygon drawn is non-equiangular and/or non-equilateral and the boundary of the polygon does not cross itself. The user may draw a polygon by simply indicating the location of the vertices of the polygon. Each polygon may have any number of vertices including three (3) or more. For example, each of the stair regions 506-512 include four vertices. As shown in the expanded view of region 512, this region includes vertices 514A-514D. However, as mentioned above, a region may be demarcated with a polygon that has as little as 3 vertices, or with one that has more than 4. By way of example, the building boundary region 504 is illustrated as being a polygon that has eighteen (18) vertices 504A-R to demarcate the building boundary of the indoor map.

Referring now back to FIG. 3, process block 315 includes receiving user input 225 that indicates the element type of the demarcated region. For example, after the user demarcates a region, they may enter, by way of user interface 402, the element type of that region, be it the building boundary, stairs, a cubicle, an elevator, an entrance, an exclusion area, an open area, or a hallway, etc. The user may indicate the element type of the demarcated region by way of a pop-up window or alternatively by a control element (e.g., button, pull-down window, radio button, etc.) included in user interface 402.

In one embodiment, the user may indicate that the element type of the demarcated region is a non-building structure, such as an annotation. As will be described below, a region that is identified as a non-building structure may be filtered out of the map when assistance data is generated. In another embodiment, rather than enter an element type of a demarcated non-building structure, the user may select to remove objects contained within the region. This feature may allow the removal of annotations or other features of the building that are not of interest for assistance data creation.

Once the input that indicates the element type is received, then process 300 proceeds to process block 320 which adds a tag to the electronic map. In one embodiment, the tag is saved to the electronic map to indicate the element type of a respective demarcated region. Thus, a tag may be generated for each region that is demarcated on the electronic map and saved with the map.

As mentioned above, the tagged electronic map may subsequently be utilized by a navigation system to generate tailored position assistance data that may be used to provide routing directions or instructions. However, not all element types are necessary for the various types of assistance data generated, while some element types are specific to a type of assistance data generation. By way of example, regions tagged as non-building structures may not be necessary for any assistance data generation. By way of another example, a cubicle may not be necessary for heat map generation. Heat map generation may include analysis, for each wireless transmitter and for each part of the electronic map, of the expected characteristic value of a wireless signal, such as RSSI or RTT. In yet another example, an elevator is specifically used for Location Context Information (LCI) disambiguation. LCI disambiguation takes wireless signals from known transmitters in different LCIs (i.e., floors) and determines the likely floor of the mobile station.

Thus, process 300 provides process block 325 for the filtering of one or more element type from the electronic map for the generation of tailored assistance data. For example, cubicles could be filtered out from the electronic map such that a heat map may be generated. Even still, all element types except for elevators and stairs may be filtered out when performing LCI disambiguation. In one embodiment, the element type(s) to be filtered from the electronic map are based on the type of tailored assistance data requested by a mobile station. For example, in response to a mobile station requesting an LCI disambiguation, a server, such as map server 105, may filter all element types except for elevators and stairs from the electronic map to generate the LCI disambiguation for the mobile device.

Next, in process block 330, the map server generates the tailored assistance data based on the filtered map and passes the necessary assistance data to the mobile station for navigation in response to a request from the mobile station. In addition to heatmap generation, and LCI disambiguation, a filtered map may be useful in other assistance data generation, such as connectivity analysis and utility analysis. Connectivity analysis generates a graph that describes the topology of the indoor map, where edges connect only if they don't cross a physical obstacle in the map. Connectivity analysis may be useful in planning a route for the mobile station, where hallway element types are left in the electronic map while open area element types are filtered out. Utility analysis generates a probability value for each part of the map that denotes the chance of a user being at a location based on topology of the indoor map. In one embodiment, having an electronic map with the building boundary tagged may allow limiting of the connectivity and heatmap analysis to within the building boundary, which may reduce the size of the associated assistance data and reduce processing time.

The order in which some or all of the process blocks appear in each process should not be deemed limiting. Rather, one of ordinary skill in the art having the benefit of the present disclosure will understand that some of the process blocks may be executed in a variety of orders not illustrated.

The teachings herein may be incorporated into (e.g., implemented within or performed by) a variety of apparatuses (e.g., devices). For example, one or more aspects taught herein may be incorporated into a mobile station, phone (e.g., a cellular phone), a personal data assistant (“PDA”), a tablet, a mobile computer, a laptop computer, a tablet, an entertainment device (e.g., a music or video device), a headset (e.g., headphones, an earpiece, etc.), a medical device (e.g., a biometric sensor, a heart rate monitor, a pedometer, an EKG device, etc.), a user I/O device, a computer, a server, a point-of-sale device, an entertainment device, a set-top box, or any other suitable device. These devices may have different power and data requirements and may result in different power profiles generated for each feature or set of features.

As used herein, a mobile station (MS) refers to a device such as a cellular or other wireless communication device, personal communication system (PCS) device, personal navigation device (PND), Personal Information Manager (PIM), Personal Digital Assistant (PDA), laptop, tablet or other suitable mobile device which is capable of receiving wireless communication and/or navigation signals. The term “mobile station” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, etc. which are capable of communication with a server, such as via the Internet, Wi-Fi, or other network, and regardless of whether satellite signal reception, assistance data reception, and/or position-related processing occurs at the device, at a server, or at another device associated with the network. Any operable combination of the above are also considered a “mobile station.”

In some aspects a wireless device may comprise an access device (e.g., a Wi-Fi access point) for a communication system. Such an access device may provide, for example, connectivity to another network (e.g., a wide area network such as the Internet or a cellular network) via a wired or wireless communication link. Accordingly, the access device may enable another device (e.g., a Wi-Fi station) to access the other network or some other functionality. In addition, it should be appreciated that one or both of the devices may be portable or, in some cases, relatively non-portable.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, engines, circuits, and algorithm steps described in connection with the embodiments disclosed herein may be implemented as electronic hardware, computer software, or combinations of both. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosures.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a non-transitory computer-readable medium. Computer-readable media can include both computer storage media and communication media including any medium that facilitates transfer of a computer program from one place to another. A storage media may be any available media that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

The previous description of the disclosed embodiments is provided to enable any person skilled in the art to make or use the present disclosures. Various modifications to these embodiments will be readily apparent to those skilled in the art, and the generic principles defined herein may be applied to other embodiments without departing from the spirit or scope of the invention. Thus, the present disclosures are not intended to be limited to the embodiments shown herein but are to be accorded the widest scope consistent with the principles and novel features disclosed herein.

What is claimed is:

1. In a computer system, a method of marking regions of an electronic map that shows a floor plan of a building, the method comprising:
receiving the electronic map showing the floor plan of the building;
displaying a user interface on a display device, the user interface comprising the electronic map;
receiving user input demarcating one or more closed regions of the electronic map;
receiving user input indicating an element type of at least one of the one or more closed regions; and
adding a tag to the electronic map to indicate the element type of the at least one of the one or more closed regions.

2. The method of claim 1, further comprising filtering one or more element types from the electronic map using tags included in the map to generate tailored assistance data for a mobile station.

3. The method of claim 2, wherein one of the one or more element types is a cubicle, and wherein the tailored assistance data includes a heat map generation based on the electronic map with cubicles filtered out.

4. The method of claim 2, wherein one of the one or more element types includes elevators and stairs, and wherein the tailored assistance data includes a location context information (LCI) disambiguation based on the electronic map with all element types filtered out except for elevators and stairs.

5. The method of claim 2, wherein the one or more element type to be filtered from the electronic map is based on the type of tailored assistance data requested by the mobile station.

6. The method of claim 1, further comprising receiving user input indicating that an area at least partially within at least one of the one or more closed regions is to be removed from the map.

7. The method of claim 1, wherein the element types are selected from the group consisting of cubicle, elevator, entrance, exclusion area, open area, hallway, stairs, and building boundary.

8. The method of claim 1, wherein the at closed region is a polygon.

9. A computer-readable medium including program code stored thereon for marking regions of an electronic map that shows a floor plan of a building structure, the program code comprising instructions to:
display a user interface on a display device, the user interface comprising the electronic map;
receive user input demarcating a closed region of the electronic map;
receive user input indicating an element type of the closed region; and
add a tag to the electronic map to indicate the element type of the closed region.

10. The computer-readable medium of claim 9, further comprising instructions to filter one or more element types from the electronic map using tags included in the map to generate tailored assistance data for a mobile station.

11. The computer-readable medium of claim 10, wherein one of the one or more element types is a cubicle, and wherein the tailored assistance data includes a heat map generation based on the electronic map with cubicles filtered out.

12. The computer-readable medium of claim 10, wherein one of the one or more element types includes elevators and stairs, and wherein the tailored assistance data includes a location context information (LCI) disambiguation based on the electronic map with all element types filtered out except for elevators and stairs.

13. The computer-readable medium of claim 10, wherein the one or more element type to be filtered from the electronic map is based on the type of tailored assistance data requested from the mobile station.

14. The computer-readable medium of claim 9, further comprising instructions to receive user input indicating that an area within the closed region is to be removed from the map.

15. The computer-readable medium of claim 9, wherein the element types are selected from the group consisting of cubicle, elevator, entrance, exclusion area, open area, hallway, stairs, and building boundary.

16. The computer-readable medium of claim 9, wherein the closed region is a polygon.

17. A map server, comprising:
memory adapted to store program code for marking regions of an electronic map that shows a floor plan of a building structure; and
a processing unit adapted to access and execute instructions included in the program code, wherein when the instructions are executed by the processing unit, the processing unit directs the map server to:
display a user interface on a display device, the user interface comprising the electronic map;
receive user input demarcating a closed region of the electronic map;
receive user input indicating an element type of the closed region; and
add a tag to the electronic map to indicate the element type of the closed region.

18. The map server of claim 17, wherein the program code further includes instructions to direct the map server to filter one or more element types from the electronic map using tags included in the map to generate tailored assistance data for a mobile station.

19. The map server of claim 18, wherein one of the one or more element types is a cubicle, and wherein the tailored assistance data includes a heat map generation based on the electronic map with cubicles filtered out.

20. The map server of claim 18, wherein one of the one or more element types includes elevators and stairs, and wherein the tailored assistance data includes a location context information (LCI) disambiguation based on the electronic map with all element types filtered out except for elevators and stairs.

21. The map server of claim 18, wherein the one or more element type to be filtered from the electronic map is based on the type of tailored assistance data requested from the mobile station.

22. The map server of claim 17, wherein the program code further includes instructions to direct the map server to receive user input indicating that an area within the closed region is to be removed from the map.

23. The map server of claim 17, wherein the element types are selected from the group consisting of cubicle, elevator, entrance, exclusion area, open area, hallway, stairs, and building boundary.

24. The map server of claim 17, wherein the closed region is a polygon.

25. A system for marking regions of an electronic map that shows a floor plan of a building structure, the system comprising:
means for displaying a user interface on a display device, the user interface comprising the electronic map;
means for receiving user input demarcating a closed region of the electronic map;
means for receiving user input indicating an element type of the closed region; and
means for adding a tag to the electronic map to indicate the element type of the closed region.

26. The system of claim 25, further comprising means for filtering one or more element types from the electronic map using tags included in the map to generate tailored assistance data for a mobile station.

27. The system of claim 26, wherein one of the one or more element types is a cubicle, and wherein the tailored assistance data includes a heat map generation based on the electronic map with cubicles filtered out.

28. The system of claim 26, wherein one of the one or more element types includes elevators and stairs, and wherein the tailored assistance data includes a location context information (LCI) disambiguation based on the electronic map with all element types filtered out except for elevators and stairs.

29. The system of claim 26, wherein the one or more element type to be filtered from the electronic map is based on the type of tailored assistance data requested from the mobile station.

30. The system of claim 25, further comprising means for receiving user input indicating that an area within the closed region is to be removed from the map.

31. The system of claim 25, wherein the element types are selected from the group consisting of cubicle, elevator, entrance, exclusion area, open area, hallway, stairs, and building boundary.

32. The system of claim 24, wherein the closed region is a polygon.
